(19) United States
(12) Patent Application Publication
(10) Pub. No.: US 2024/0388459 A1
(43) Pub. Date: Nov. 21, 2024

(54) SYSTEM FOR PROVIDING A COMMUNITY LIVE STREAMING AND METHOD THEREOF

(71) Applicant: JJAANN Company, Seoul (KR)

(72) Inventor: Samuel PARK, Seoul (KR)

(21) Appl. No.: 18/666,737

(22) Filed: May 16, 2024

(30) Foreign Application Priority Data
May 18, 2023 (KR) 10-2023-0064159

(51) Int. Cl. H04L 12/18; H04L 43/08; H04L 65/1093; H04L 65/80; H04N 23/90

(52) U.S. Cl. CPC H04L 12/1822; H04L 43/08; H04L 65/1093; H04L 65/80; H04N 23/90

(57) ABSTRACT

A community live streaming system includes a plurality of user terminals and a server providing a live streaming service, wherein the plurality of user terminals includes a host streamer terminal for creating a party room; and at least one participant terminal for participating in the party room, wherein the server includes: a setting checking unit; a network quality measurement unit; a candidate streamer list generation unit; and a service support unit.

### TECHNICAL FIELD

The present invention relates to a system and method for providing community live streaming, more specifically relates to the system and method wherein a host streamer who creates a party room for a specific purpose and community members participating in the party room can become fellow streamers at the discretion of the host streamer during the live stream and collaborate each other in live streaming.

### TECHNICAL BACKGROUND

In recent years, with the widespread availability of electronic devices such as computers, smartphones, and tablet PCs, various forms of video content that can be streamed and viewed online using these devices have emerged.

Furthermore, the number of viewers spending their leisure time watching various videos using electronic devices is increasing due to environmental and spatial constraints. Particularly, in recent years, there has been a rise in viewers watching real-time video through live streaming services. These services enable viewers to watch live video by transmitting real-time video data received from the video transmission terminal of a live streamer (video transmitter) to the viewer's video playback terminal.

In live streaming, users primarily communicate with each other through chat rooms, which are important components of the live streaming experience. They also interact with the live streamer through features such as emotes, emoticons, or donations (financial support), providing alternative means of communication.

Additionally, there are cases where other streamers join together to conduct live broadcasts through co-streaming.

However, in conventional live streaming services, the participation of one or more streamers in a live stream is predetermined, excluding other users from the stream and restricting them to watching only the predetermined streams. This asymmetry in streaming rights poses a problem in terms of community engagement, as it discourages active participation from community members due to the lack of shared streaming permissions, despite the promotion of interactive live streaming.

Accordingly, the present applicant intends to provide a community live streaming system, wherein a host streamer can select collaborating streamers from among users participating in the live stream and conduct live streaming with them during the session.

### PROBLEMS TO BE SOLVED

An objective of the present invention is to provide a system and method for community live streaming that allow a host streamer who has created a party room for a specific purpose and community members participating in the party room to become fellow streamers at the discretion of the host streamer during the live stream in a collaborative manner.

More specifically, the objective of the present invention is to provide the system and method that aids the host streamer in selecting fellow streamers by offering a list of candidate streamers based on the participants' camera/audio status and network quality.

Additionally, another objective of the present invention is to provide a system and method that assists in the selection of fellow streamers by recommending candidates based on the similarity of tastes between the host streamer and the participants.

### SUMMARY OF INVENTION

To address the above challenges, in one embodiment of the present invention, a community live streaming system may comprise a plurality of user terminals and a server providing a live streaming service, wherein the plurality of user terminals may include a host streamer terminal that creates a party room, and a participant terminal that participates in the party room.

In this case, the server may comprise: a setting checking unit for checking the on/off status of the camera and microphone of the at least one participant terminal upon receiving a request to enter the party room from said at least one participant terminal; a network quality measurement unit for assessing the network quality of the at least one participant terminal; a candidate streamer list generation unit for generating and providing a list of candidate streamers to the host streamer terminal, the list being based on the on/off status of the camera and microphone and the network quality of the at least one participant terminal; and a service support unit for outputting camera images from the host streamer terminal and the at least one participant terminal, selected as fellow streamers by the host streamer terminal, to predetermined areas on a live streaming screen and to provide said images to the user terminals participating in the party room.

Further, the network quality measurement unit may be further configured to determine a network quality rating based on bandwidth, latency, packet loss, and playback buffer latency of the participant terminals.

Further, the service support unit may be further configured to support differential video quality based on the network quality rating of the participant terminals.

Further, the candidate streamer list generation unit may be further configured to provide a list of candidate streamers to the host streamer terminal comprising participant information corresponding to participant terminals with the camera and microphone turned on and arranged in order of increasing network quality rating.

The system may further include a management unit configured to store and manage user information including personal and interest information, party room information, and participant activity history; and a recommendation unit configured to compare the user information with the party room information and the user information of the host streamer, respectively, and recommend party rooms and host streamers in order of taste similarity to the user.

The system may further a similarity calculator configured to calculate the similarity of a party room by comparing the party room information with the user information and activity history of a party room participant, wherein the candidate streamer list generation unit is further configured to generate a list of candidate streamers based on the on/off status of cameras and microphones on at least one participant terminal, network quality, and similarity to the party room.

The user information may include at least one of age, gender, country/region, and language, and categorical interest information, the party room information includes at least one of category, party room title, party room description, related tags, and capacity, and the participant activity history information may include at least one of number and frequency of party room participation, donation information, party evaluation score, number of fellow streamer requests, and number of fellow streamer selections.

The system may further comprise a UI generation unit configured to provide a user interface (UI) to the user terminal when the party room is created, wherein the UI comprises a background area, multiple split screen areas nested within the background area, and multiple function icons.

The multiple split screen areas include multiple camera output areas of fellow streamers centered on the camera output area of the host streamer terminal, each camera output area of the fellow streamers having a set seat number.

Further, The system may further comprise a pre-screening screen configured to select a fellow streamer of a specified seat number by providing a list of candidate streamers including participant information when a camera output area of a fellow streamer at the host streamer terminal is selected.

Furthermore, the UI generation unit may provide a pre-screening screen for the corresponding seat number when selecting the camera output area of the fellow streamer on the venue streamer terminal.

The pre-screening screen may comprise a main frame area that provides a candidate preview including participant information and camera output video of the participant's device, and a list of candidate streamers with the highest priority, arranged in priority order of the candidate streamer list, superimposed on the preview.

Further, the service support unit, when a list of candidate streamers in the main frame area is selected by the host stream.

Meanwhile, according to another embodiment of the present invention, a live streaming service method of a system may comprise a host streamer terminal creating a party room, a plurality of user terminals including participant terminals participating in the party room, and a server providing the live streaming service is as follows: (a) creating a party room via the host streamer terminal; (b) receiving a party room entry request from the participant terminal and checking the on/off status of the camera and microphone of the participant terminal by the server; (c) assessing the network quality of the participant terminal by the server; (d) providing a list of candidate streamers to the host streamer terminal by the server, the list based on the on/off status of the camera and microphone and the network quality of at least one participant terminal; (e) selecting a fellow streamer by the host streamer terminal; and (f) outputting camera footage from the host streamer terminal and camera footage of the participant terminals selected as fellow streamers to a predetermined area of a livestreaming screen and providing the same to user terminals participating in the party room.

Accordingly, a community live streaming system and method according to one embodiment of this invention can provide a live streaming platform service that enables a host streamer, who creates a party room for a specific purpose, and a community member participating in the party room, to collaborate in live streaming as fellow streamers by the host's selection during the live broadcast.

In this case, participant scores are calculated based on several criteria: the participant's camera/audio status, network quality, similarity of tastes between the host streamer and the participant, similarity between the participant's user information and party room details, participant activity history, and their willingness to become a fellow streamer. A list of candidate streamers is then provided, sorted by these scores, to assist the host streamer in selecting fellow streamers.

Furthermore, the system of the present invention can recommend matching party room and host streamers to the user based on user-specific preference information (such as personal information and interest information).

Furthermore, the system of the present invention can support stable live streaming of a party room by categorizing network quality classes through network quality measurement of participants, and controlling video/audio quality according to the categorized network quality classes.

Furthermore, the system of the present disclosure can provide a user-specific (user, host streamer, fellow streamer, candidate streamer, viewer) authorized UI to facilitate party room creation and setup, interaction functions (chat, raise hand (fellow streamer willing to join), viewing and searching for host streamer/party room recommendations, etc. In particular, a list of candidate streamers and a pre-screening screen can be provided to facilitate the selection of fellow hosts for the host streamer.

However, the effects of the present invention are not limited by the above examples, and many more are included herein and other exemplary embodiments of the present invention are suggested in the description and drawings.

### BRIEF DESCRIPTION OF DRAWINGS

FIG. 1 is a schematic illustration of a community live streaming system according to one embodiment of the present invention.

FIG. 2 is a diagram illustrating a plurality of party rooms being live streamed in the community live streaming system of FIG. 1.

FIG. 3 is a block diagram illustrating a schematic configuration of a user terminal according to one embodiment of the present invention.

FIG. 4 is a block diagram illustrating a schematic configuration of a server according to one embodiment of the present invention.

FIG. 5 is a flow chart to illustrate a method for providing community live streaming, according to one embodiment of the present invention.

FIG. 6 illustrates a party room screen according to one embodiment of the present invention.

FIG. 7 is a block diagram illustrating a schematic configuration of a host streamer mode according to one embodiment of the present invention.

FIG. 8 illustrates a party room entry screen according to one embodiment of the present invention.

FIG. 9 illustrates a pre-screening screen according to one embodiment of the present invention.

FIG. 10 is a block diagram illustrating a schematic configuration of a server according to another embodiment of the present invention.

FIG. 11 is a flow chart to illustrate recommendation-based fellow streamer selection according to another embodiment of the present invention.

FIG. 12 is a flow chart to illustrate how a participant may join a party room according to one embodiment of the present invention.

### DETAILED DESCRIPTION

The following description is merely illustrative of the principles of the invention. Therefore, those skilled in the art will be able to implement the principles of the invention and invent various devices that are included in the concepts and scope of the invention, even though not specifically described or shown herein. Furthermore, it is to be understood that all conditional terms and embodiments listed herein are expressly intended solely for the purpose of enabling the concepts of the invention to be understood in principle, and not to be limited to the embodiments and conditions specifically listed as such.

Also, in the following descriptions, ordinal expressions such as first, second, etc. are intended to describe objects that are equivalent and independent of each other, and should be understood to have no main/sub or master/slave implications in that order.

The foregoing objects, features and advantages will become more apparent from the following detailed description with reference to the accompanying drawings, which will enable one having ordinary skill in the technical field to which the invention belongs to practice the technical ideas of the invention with ease.

Each of the features of the various embodiments of the present invention can be combined or combined with each other, in unit or in whole, and as will be fully appreciated by those skilled in the art, various technical interlockings and operations are possible, and each embodiment can be practiced independently of each other or together in association.

Hereinafter, various embodiments of the present invention will be described in detail with reference to the accompanying drawings.

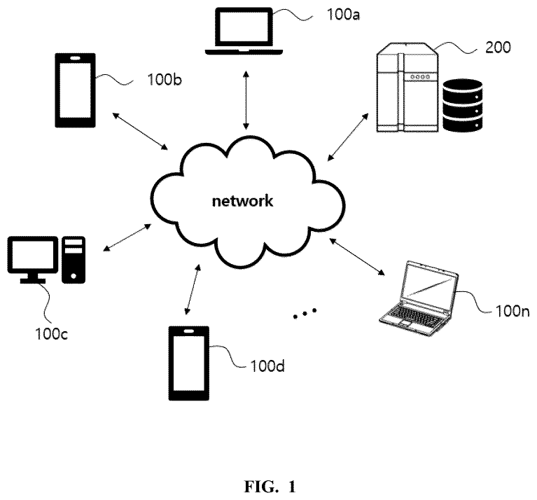

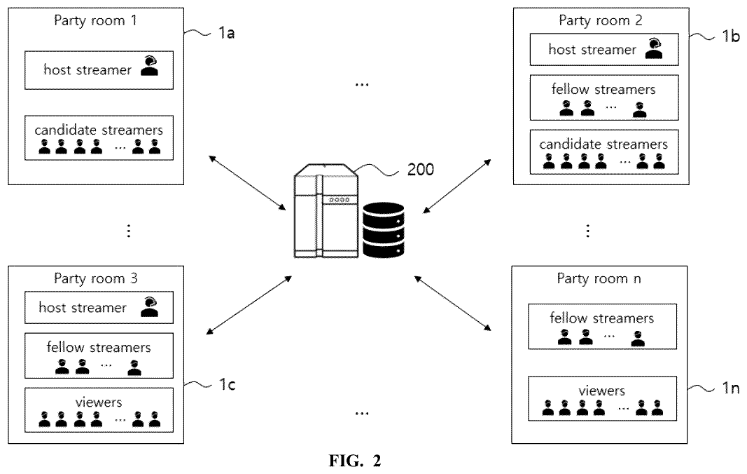

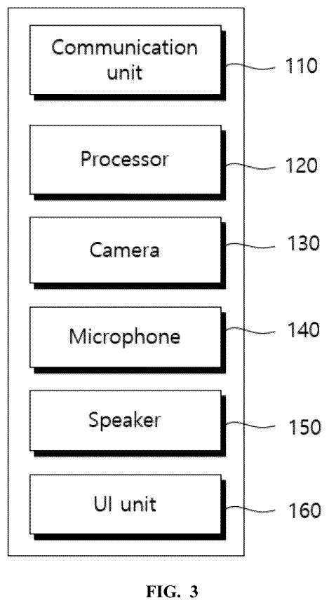

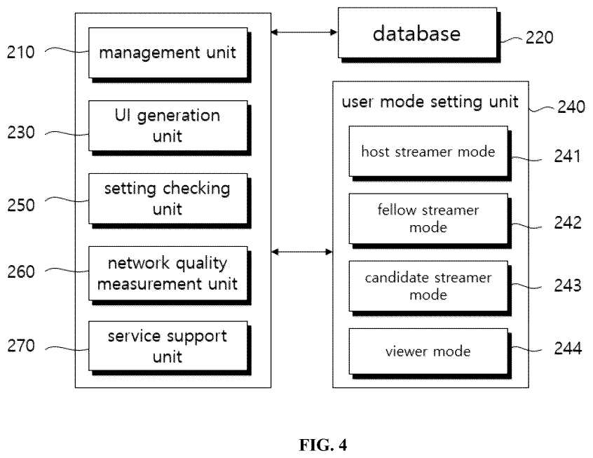

FIG. 1 is a diagram schematically illustrating a community live streaming system according to one embodiment of the present invention. FIG. 2 is a diagram illustrating a plurality of party rooms being live streamed in the community live streaming system of FIG. 1. FIG. 3 is a block diagram illustrating a schematic configuration of a user terminal according to one embodiment of the present invention. FIG. 4 is a block diagram illustrating a schematic configuration of a server according to one embodiment of the present invention.

The community live streaming system of the present invention (hereinafter referred to as the streaming system) can provide a platform for a plurality of users to form a non-contact community (referred to as the party room in FIG. 2) using various devices and collaborate to create and stream live contents.

Here, a party room is a non-contact community created for a specific purpose, and may be created by a particular user (host streamer) and formed by a plurality of other users (participants) joining the party room. In particular, in the present invention, the party room can provide a community livestreaming service for hosting parties and interacting with participants having common interests in categories based on specific purposes. The party room can function as an N:N video chat service area and may be implemented in the present invention based on WebRTC-peer-to-peer (P2P) architecture. Additionally, if necessary to address issues such as quality or security degradation, the party room may also be implemented using relay servers such as Selective Forwarding Unit (SFU) and Multi-point Control Unit (MCU). Referring to FIG. 1, the streaming system according to one embodiment of the present invention may comprise multiple user terminals 100a to 100n receiving the community live streaming service and a server 200 providing the community live streaming service.

Here, the user terminals 100a to 100n can be various devices such as PCs, laptops, tablets, smartphones, etc., used by the user. These terminals may have an app installed for the community live streaming service or access the service through a web-based browser.

In the present invention, users are categorized as host streamers, participants (also known as candidate streamers), fellow streamers, and viewers. Each user's terminal is classified accordingly as host streamer terminals, participant terminals (or candidate streamer terminals), fellow streamer terminals, and viewer terminals. Moreover, the user mode setting unit 240 of the server 200 assigns differentiated permissions to each category of users within the party room.

The host streamer, who creates the party room, can also serve as the moderator of the live stream. This role grants the host streamer comprehensive control over the party room, encompassing its setup, event creation, live streaming content production, selection of fellow streamers, participant management, and interactive features such as chat and games.

Participants are users who join a party room created by the host streamer and can be categorized as either fellow streamers or viewers. All participants have the potential to become streamer candidates. The participants may be granted permissions to set up their personal camera and audio, request to become fellow streamers, and access interactive features such as chat and games.

Fellow streamers can be selected by the host streamer during a live stream from among

the candidate streamers in the party room. Once selected, they become the participants who can join the party room as the video or voice live streamer.

A viewer is a participant in the party room who is not a fellow streamer. Viewers can watch the live streamed video and participate in the live stream solely through the chat service.

Referring to FIG. 2, a party room forms a community that includes at least one of a host streamer, a fellow streamer, a candidate streamer, and a viewer, and there can exist multiple such party rooms. For example, depending on the settings of the host streamer, various non-contact communities can be formed, such as Party Room la where pre-screening of fellow streamer candidates is ongoing, Party Room 2 and Party Room 3 where pre-screening is complete, and Party Room n where fellow streamers are selected without pre-screening.

In this scenario, the distribution of individuals in a party room may be 1:m+n:m:n (host streamer:candidate streamers:fellow streamers:viewers), where m and n are natural numbers and n could be greater than m. For example, m could be 6, but the number of people can be adjusted based on the situation and needs. It's also possible for n to be less than m, and there might be no m or n.

Referring to FIG. 3, the user terminals 100a through 100n may include a communication unit 110, a processor 120, a camera 130, a microphone 140, a speaker 150, and a UI unit 160. The presence and configuration of the communication module, processor, camera, microphone, and speaker may restrict to be authorized as host streamers and fellow streamers.

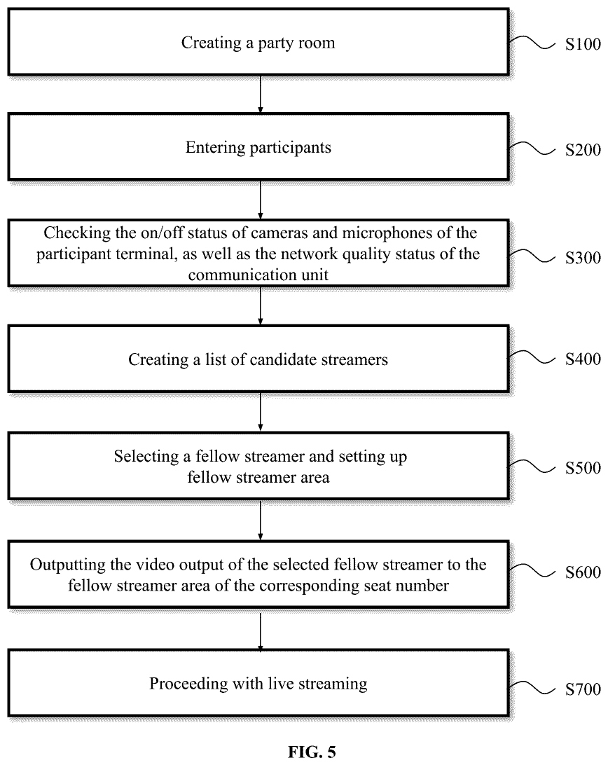

The server 200 may serve as a service platform which provides community live streaming services. Referring to FIG. 4, in one embodiment of the present invention, server 200 may include a management unit 210, a database 220, a UI generation unit 230, a user mode setting unit 240, a setting checking unit 250, a network quality measurement unit 260, and a service support unit 270. The functions and operations of each component detailed in FIGS. 3 and 4 will be described with reference to FIGS. 5-9. FIG. 5 is a flowchart illustrating a method of providing community live streaming according to one embodiment of this disclosure.

The communication unit 110 in the user terminals 100a-100n can enable communication with the server 200 and/or other user terminals via the network. The communication unit 110 may consist of communication modules such as wired, 3G, 4G, 5G, and/or WiFi, which are included in the terminal. In the case of a WiFi module, it can communicate through an external router.

The processor 120 can control and operate the overall setup for providing a community live streaming service, whether app-based or web-based. Additionally, the camera 130 can capture video of a user and transmit it in real time, while the microphone 140 can output audio signals, such as the user's voice, in real time. Furthermore, the speaker 150 can output audio signals generated in the party room to the user's terminal.

The UI unit 160 serves as a user interface for using the service and can also be provided by the UI generation unit 230 of server 200. It can handle functions of an input unit which requests login, party room creation and setup and interaction functions during live streaming as well as functions of an output unit which receives and delivers responses from server 200 in response to the requests.

The user can sign up or log in through the UI unit 160. The UI generation unit 230 provides a UI for signing up or logging in, and when receiving user information such as personal information and interest information of the user entered through the UI, the management unit 210 can store and manage user-specific information in the DB 220.

In this case, personal information may include age, gender, country/region, and language, among others. Interest information may be categorized and stored in areas such as Sports, Music and Entertainment, Global Cuisine Exchange, Art and Creativity, Travel and Adventure, Languages, Movies/TV, Games/eSports, Profession, Health, Exercise, Friends/Family, etc. However, these categories are not exhaustive and can be further subdivided and expanded.

Additionally, a user may create a party room via UI unit 160, which receives party room information through the party room creation UI. This party room information may include the category, party room title, introduction, related tags, capacity, and password. Furthermore, the user's activity history as a host streamer, such as popularity, frequency of hosting and participating in parties, and ratings and reviews, may also be stored. The management unit 210 can then match and store both the created party room information and the activity history with the user's information in the database (DB) 220.

Additionally, the management unit 210 may store and manage information of user participating activities including users' party participation history (e.g., donations, number and frequency of party room entries, etc.), party evaluation scores, interactions (e.g., number of times a fellow streamer has raised a hand to express a wish, chats, games, emojis, etc.), the number of times a fellow streamer is selected, and the number of times a friend is invited and shared.

Moreover, the user mode setting unit 240 can provide a host streamer mode 241 when a party room is created on the user terminal. When a user terminal joins a party room as a participant, the user mode setting unit 240 may set the user terminal as a candidate streamer through the candidate streamer mode 243 and provide either a fellow streamer mode 242 or a viewer mode 243 depending on whether the fellow streamer is selected, and may differentially grant permissions in the party room based on each mode.

Specifically, the host streamer mode 241 grants permissions corresponding to the host streamer to the user of the user terminal. The host streamer mode 241 may also grant the host streamer terminal the permissions of a live streamer, who also serves as the host or facilitator of the live streaming event. As such, the host streamer can set up and manage the live stream, guide the overall direction and tone of the live stream, invite fellow streamers to participate, and lead discussions or activities that occur during the live stream.

Additionally, the fellow streamer mode 242 grants permissions corresponding to fellow streamers to the user of the user terminal, such that the fellow streamer mode 242 may allow the fellow streamer terminal to participate in a live stream with live streamer permissions together with the host streamer, and other fellow streamers. Consequently, the fellow streamer can be selected from among candidate streamers and invited by the host streamer, and the fellow streamers can collaborate to create a live stream.

In addition, the candidate streamer mode 243 may grant permissions corresponding to a candidate streamer to a user of the user terminal. This mode allows the candidate streamer terminal to receive permissions as a potential streamer for the live streaming event. A candidate streamer is identified as a potential candidate by the host streamer but has not yet been selected or confirmed as a fellow streamer. A list of candidate streamers may be provided based on a curation algorithm.

Furthermore, the viewer mode 244 grants permissions corresponding to a viewer to a user of the user terminal, allowing the viewer terminal to watch the live stream. Therefore, the viewer is distinguished from other types of streamers (host streamers, fellow streamers, and candidate streamers) because they participate in the live stream only through the chat room.

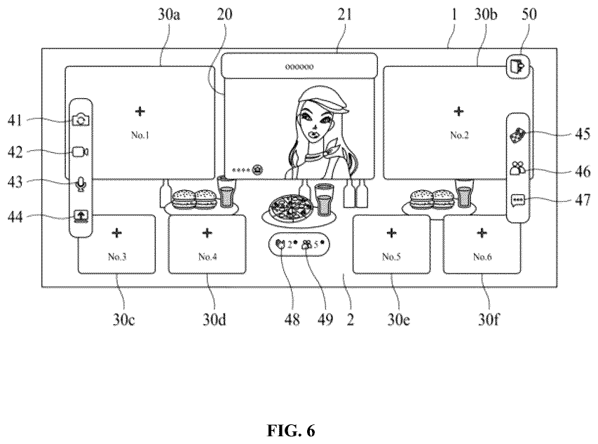

Based on the permissions associated with each mode in the user mode setting unit 240, the live streaming of the party room can proceed according to the method of FIG. 5. As illustrated in FIG. 5, when a party room is created (S100) by a specific user terminal (e.g., 100c), a live streaming screen 1 generated by the UI generation unit 230 may be provided as shown in FIG. 6. At this time, the host streamer terminal 100c may exercise the permissions according to the host streamer mode 241.

FIG. 6 illustrates a party room screen according to one embodiment of the present invention. FIG. 6 shows a streaming screen 1 that can be shared by all participants in a party room. The streaming screen 1 may include a background area 2, a plurality of split screen areas 20, 30a to 30f overlapped on the background area 2, and a plurality of function icons 51 to 50.

Here, the background 2 may be designated by the host streamer terminal and can be an image or video of party food or similar, set according to a category.

In addition, camera output area 20 of the host streamer terminal and the camera output areas 30a to 30f of several fellow streamers may be arranged in the split-screen area. A seat number may be assigned in the camera output areas of the fellow streamers. At this time, a party room title 21 may be displayed on the camera output area 20 of the host streamer terminal.

Moreover, function icons are authorized for use by both the host streamer device and each participant device. The settings of the function icons 41-44, and 50 are personal function icons that can be configured on their own devices. These include a camera switch 41 to alternate the output of their device between their own camera or streaming screen, video on/off 42 to control their camera output, microphone on/off 43, screen sharing 44, and an exit icon 50 to leave the party room.

Furthermore, interaction features 45-49 may include participation function 45 in events such as games, surveys, ratings, etc., a list of participants 46, chatting 47, raising hands 48 to indicate a desire to be a fellow streamer, and the current number of participants 49.

The streaming screen 1 depicted in FIG. 6 represents one embodiment, which can be varied through modifications, additions, or deletions of features and design.

The host streamer terminal 100c is authorized according to the host streamer mode 241 to perform various settings of the party room via the live streaming screen 1.

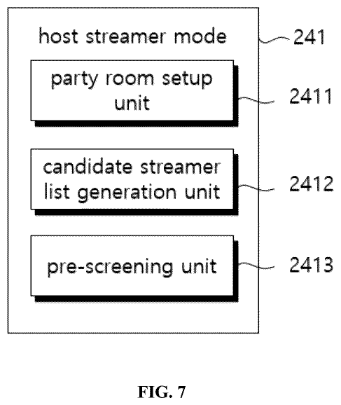

FIG. 7 is a block diagram illustrating the schematic configuration of the host streamer mode according to one embodiment of the present invention. Referring to FIG. 7, host streamer mode 241 may comprise a party room setup unit 2411, a candidate streamer list generation unit 2412, and a pre-screening unit 2413.

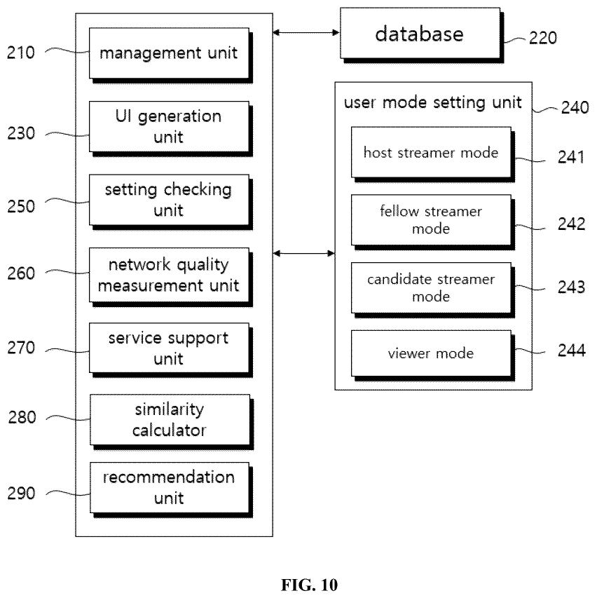

Through the party room setup unit 2411, the host streamer terminal 100c can prepare for streaming by setting up the party room (inserting background images and stickers, configuring camera/audio settings, etc.) as shown on the screen of FIG. 10.

Next, when participants enter the party room created in step S100 of FIG. 5 (S200), the server 200 can check the on/off status of cameras 130 and microphones 140 of the participants' terminal, as well as the network quality status of the communication unit 110 (S300).

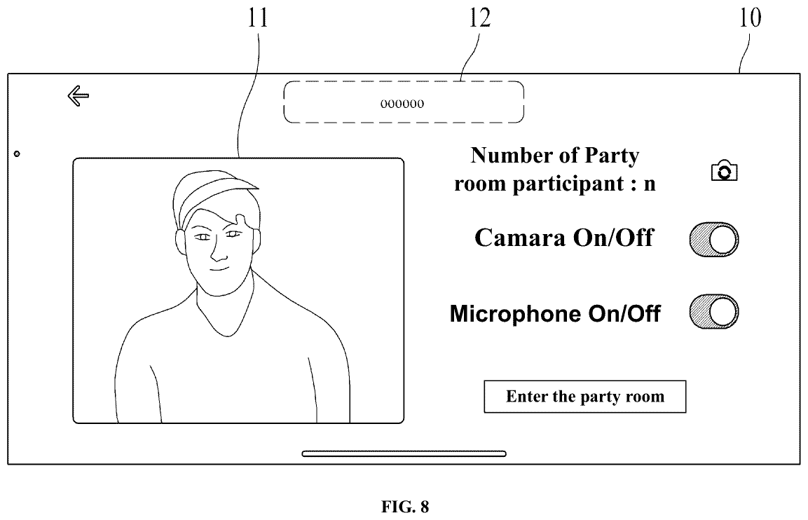

For example, a participant's party room entry screen can be referred to in FIG. 8. FIG. 8 is a diagram illustrating the party room entry screen 10 according to one embodiment of the invention.

As shown in FIG. 8, a participant wishing to join the party room can view the UI screen (party room entry screen 10) via the participant terminal. On UI screen 10, the participant can see the video output 11 from their camera, the title of the party room 12, and the current number of other participants. The participant can then configure their camera and microphone settings to either on or off before entering the party room.

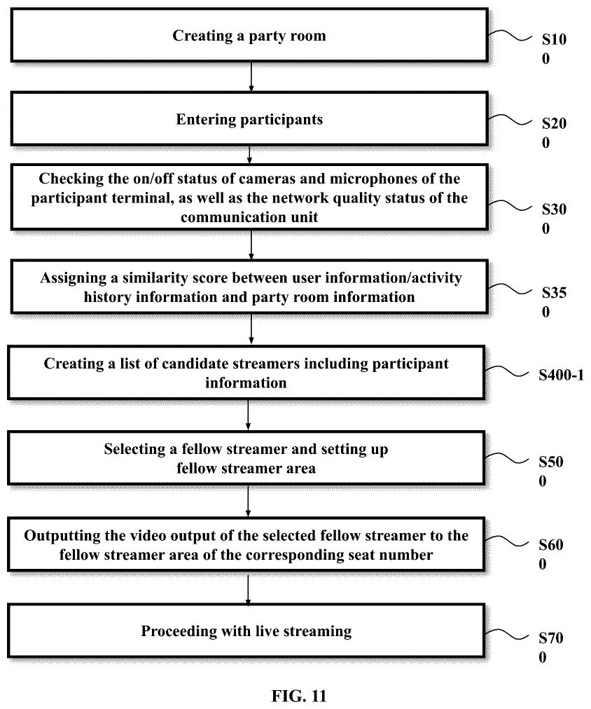

At this time, the setting checking unit 250 of the server 200 may check whether the camera/microphone of the participant device is on or off. The on/off status can be checked from the on/off settings entered by the participant at the time of participation, as shown in FIG. 11, or by checking whether the devices are connected.

Further, the network quality measurement unit 260 of the server 200 may perform network quality tests on the communication unit 110 of the participant terminals to distinguish network quality ratings.

Specifically, the network quality measurement unit 260 may determine the bandwidth, latency, packet loss, and playback buffer latency to calculate a rating score.

Internet speed significantly impacts video chat quality. Insufficient bandwidth can result in poor image quality or delays in screen and voice transmission. In this invention, bandwidth measurements assess the user's upload and download speeds.

Typically, video chats use 128 Kbps to send and receive images. Based on this, the download and upload bandwidths can be calculated as follows:
Download bandwidth: (Number of video chat participants−Number of host streamers)*128 Kbps
Upload bandwidth: (Number of video chat participants−Number of host streamers+Number of monitoring servers)*128 Kbps

Here, the number of participants in the video chat can be the sum of the number of host streamers 1 and the number of selected fellow streamers, the monitoring server can be a node for auditing the quality of service and video, which can be the network quality measurement unit 260, and the number of monitoring servers can be 1.

For example, if six fellow streamers are selected, a minimum download bandwidth of 768 Kbps and an upload bandwidth of 896 Kbps are required for reliable transmission. Moreover, at the user end, the network may also be utilized for chat and other applications in addition to video. Considering this, the following criteria for network quality levels can be defined:
Grade A: 2,000 Kbps (2 Mbps) or more, upload and download, respectively
Grade B: 1,200 Kbps to 1,999 Kbps for uploads and downloads, respectively
Grade C: 900 Kbps to 1,200 Kbps for upload and download, respectively
Grade D: 700 Kbps to 899 Kbps
Grade F: 700 Kbps or less

Latency is also measured using a ping test, which determines the delay time between the communication unit 110 of the participant's device and the chat server 200. The ping command calculates the Round Trip Time (RTT), and since a latency of 150 ms or less does not significantly affect video chat, the latency criteria are defined as follows:

Class A: 0 ms to 50 ms, Class B: 51 ms to 100 ms, Class C: 101 ms to 150 ms Grade D: 151 ms to 200 ms, Grade F: 201 ms or more

Packet loss testing can also be conducted using ping commands with ICMP packets to determine the percentage of lost packets. This test can be performed using methods other than

ICMP. Packet loss of 1% or less does not significantly impact video chat quality. Based on this, the packet loss thresholds are defined as follows:

Grade A: 0% to 0.2%; Grade B: 0.21% to 0.5%; Grade C: 0.51% to 1%.

Grade D: 1.01% to 2%, Grade F: 2.01% or more

Furthermore, a playback buffer delay of 500 ms or less is appropriate for live video chat, so the playback buffer delay criteria are defined as follows:

Class A: 0 ms to 100 ms, Class B: 101 ms to 250 ms, Class C: 251 ms to 400 ms

Grade D: 401 ms to 500 ms, Grade F: 501 ms or more

The network quality measurement unit 260 can assign scores to each category calculated for bandwidth, latency, packet loss, and playback buffer delay, and may apply weights to each metric to compute a rating score.

Further the network quality rating can be categorized as the weighted summed score of (bandwidth rating score and bandwidth weight), (latency rating score and latency weight), (packet loss rating score and packet loss weight), and (playback buffer delay rating score and playback buffer delay weight).

For example, you can assign a weight of 0.5 for bandwidth, 0.3 for latency, 0.1 for packet loss, and 0.1 for replay buffer delay, with a weight of 0.5 for bandwidth, 0.3 for latency, 0.1 for packet loss, and 0.1 for replay buffer delay.

You can also categorize network quality ratings based on the summed score, for example: Level 1:4.5 to 5.0, Level 2:4.0 to 4.4, Level 3:3.6 to 3.9,

Level 4:3.0 to 3.5, Level 5: Less than 3.0

The network quality measurement unit 260 transmits the calculated network quality ratings to the service support unit 270 and the user mode setting unit's host streamer mode 241 to facilitate the generation of a candidate streamer list.

Subsequently, the candidate streamer list generation unit 2412 within the host streamer mode 241 of server 200 uses the on/off status of the participants' cameras and microphones, along with their network quality ratings, to score the participants. It then creates a list of candidate streamers ranked by these scores, which is provided to the host streamer terminal (S400).

The list of candidate streamers may include information about the participant, such as whether the camera is on or off, whether the microphone is on or off, and the network quality rating, and the participant score, where the participant score may be measured in order of increasing network quality rating.

Meanwhile, if new participants join during the pre-streaming period, the process from steps S200 to S400 can be repeated to update the candidate streamer list.

While the embodiment of FIG. 5 describes an embodiment in which a participant priority is determined based on camera on/off, microphone on/off, and network quality rating when generating a list of candidate streamers, participant priority can also be determined based on first-come, first-served, random, participant voting, or matching similarity to the host streamer.

Alternatively, when generating a list of candidate streamers, participant priority can be based on a combination of camera on/off, microphone on/off, network quality rating, and matching similarity to the host streamer.

At this time, the participant prioritization method may be selected by the host streamer terminal.

Next, the host streamer terminal can select and assign a fellow streamer to specific camera output areas 30a-30f on the streaming screen (FIG. 6). Each of these camera output areas is assigned a seat number. When the host streamer terminal clicks on a specific seat number's camera output area, the pre-screening unit 2413 can provide a pre-screening screen to the host streamer terminal.

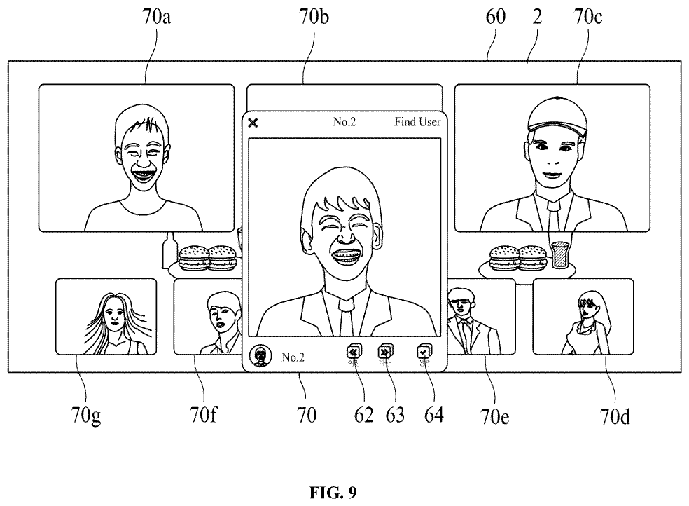

For instance, the pre-screening screen can be as depicted in FIG. 9, which is designed to illustrate a pre-screening screen according to one embodiment of the invention. Referencing FIG. 9, the pre-screening unit 2413 may provide a pre-screening screen 60 that includes a candidate streamer list generated by the candidate streamer list generation unit 2412.

Pre-screening involves selecting a fellow streamer for a specific camera output area (e.g., 30b) corresponding to a seat number (e.g., no. 2) clicked by the host streamer terminal. The pre-screening screen 60 previews the list of candidate streamers ranked by score, and the main frame area 70 may display the highest priority candidate streamers.

In this case, a main frame area 70 is provided overlapped on the center of the plurality of previewed candidate streamer lists, and a prioritized list of candidate streamers can be moved to the main frame area 70 by selecting the previous 62 or next 63. In this case, the position of the plurality of previewed candidate streamer lists may also be shifted to the left or right in priority order.

Alternatively, a specific list of preview candidate streamers may be clicked, selected, or dragged to display in the main frame area 70. The list of candidate streamers displayed in the main frame area 70 may include video output from participant terminals that are live candidates and participant information, such as camera on/off, microphone on/off, network quality rating, candidate score, etc.

Next, the candidate streamer list displayed in the main frame area 70 is selected (e.g. check box 64 is checked), and the candidate may be selected as a fellow streamer for seat number 2. In step S500, a fellow streamer for each seat number can be selected in the same way to set up the fellow streamer area.

Next, the video output from the selected fellow streamer's terminal (corresponding camera) can be output to the fellow streamer area of the corresponding seat number (S600).

When the video of the selected fellow streamer is displayed in the fellow streamer area of each seat number, the host streamer terminal can proceed with live streaming collaborating with multiple fellow streamers (S700). At this time, the fellow streamer area may not be fully filled depending on the settings of the host streamer device.

On the other hand, the host streamer device may delete the party room, or it may keep the party room without deleting it. Participants may still be in the party room when the host streamer exits 50 from the party room.

In this case, the host streamer can enable auto-staging, and if auto-staging is enabled, up to a preset number of participants can be automatically selected as fellow streamers on a first-come, first-served basis (no pre-screening), or if auto-staging is not enabled in the absence of the host streamer, participants can only communicate via chat.

The service support unit 270 may support live streaming corresponding to the network quality rating calculated by the network quality measurement unit 260. For example, video chat quality may be adjusted based on the network quality rating of the participant's device, and differential support may be provided, such as providing low-quality video or discontinuing video transmission for a rating as low as class D.

Meanwhile, FIG. 10 is a block diagram illustrating a schematic configuration of a server according to another embodiment of the present invention. Referring to FIG. 10, the server of FIG. 10 may include a management unit 210, a database 220, a UI generation unit 230, a user mode setting unit 240, a setting checking unit 250, a network quality measurement unit 260, a service support unit 270, a similarity calculator 280, and a recommendation unit 290. That is, a server according to another embodiment of FIG. 10 may further include a similarity calculator 280 and a recommendation unit 290 in the configuration of the server 200 according to one embodiment of FIG. 4.

In this embodiment, since the same signed configurations perform the same functions and

behaviors, only the additional configurations of similarity calculator 280, recommendation unit 290, and candidate streamer list generation unit 2412 of FIG. 7, which perform additional functions, will be described in detail.

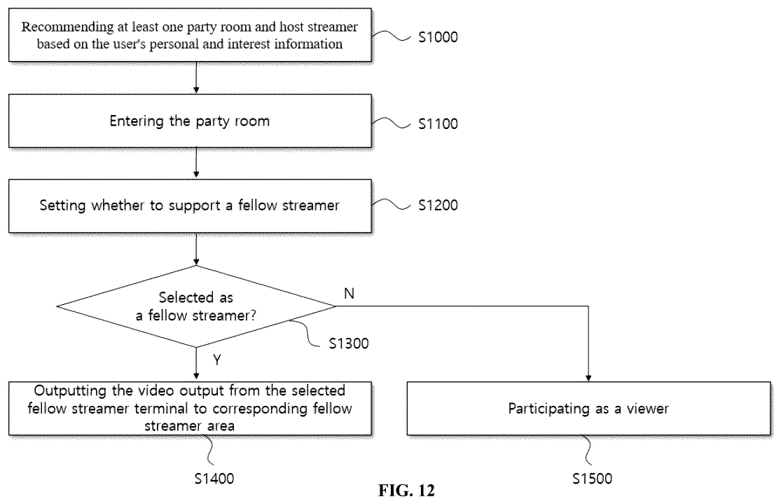

Further, corresponding methods will be described with reference to FIGS. 11 and 12. FIG. 11 is a flow chart to illustrate recommendation-based fellow streamer selection according to another embodiment of the present disclosure. FIG. 11 is identical to the method of FIG. 5, except that the list of candidate streamers reflects similarity. Accordingly, the description of each step is omitted as it is the same as in FIGS. 5, and S350 (similarity calculation step) and S400-1 (candidate streamer list generation step) will be described in detail.

Based on the user-specific information stored and maintained by the management unit 210, the similarity calculator 280 may calculate the similarity of the user's tastes to the registered party rooms and the similarity of the user's tastes to the host streamer of the party room.

In this scenario, upon the user's initial login and registration, the recommendation unit 290 can recommend party rooms by comparing the user's information (personal information and interest information) with the party room information based on similarity. Additionally, the recommendation unit 290 may also recommend host streamers by comparing the user's information (personal information and interest information) with that of the host streamers, prioritizing those with higher similarity.

Furthermore, the similarity calculator 280 may compare the party room information with the information of the party room participants (candidate streamers), which includes user information and participant activity history. It can then assign scores to the participants in descending order of similarity to the party room (S350).

The candidate streamer list generation unit 2412 of the host streamer mode 241 of the server 200 may calculate a participant score based on the camera and microphone on/off status of the participant terminal, a network quality rating, and an assigned score based on the similarity between the participant and the partition room, and generate a list of candidate streamers in order of the highest participant score and provide the list to the host streamer terminal (S400-1).

The list of candidate streamers may include information about the participant, such as whether the camera and microphone are on, whether the network quality rating is high, and the similarity score is high, and the list of candidate streamers may include information about the participant, such as whether the camera is on or off, whether the microphone is on or off, and the network quality rating, the similarity score, and the participant score.

On the other hand, if a new participant enters during the pre-streaming period, you can update the list of candidate streamers by repeating steps S200 through S400-1.

FIG. 12 illustrates how a participant may join a party room according to one embodiment of the present invention.

Referring to FIG. 12, when a user signs up or logs in, the similarity calculator 280 may calculate, based on user-specific information stored and maintained by the management unit 210 (e.g., the user's personal information and interest information), a taste similarity between the user and a registered party room, and a taste similarity between the user and the host streamer of the party room.

In other words, the server 200 may recommend at least one of the party room and host streamers based on the user's personal and interest information upon the user's login or signup (S1000).

For example, the main screen upon login can display thumbnails of party rooms, currently live-streaming rooms can be displayed at the top, recommended rooms can be displayed at the bottom, and users can also search for party rooms through the search function.

Next, when the user selects a specific party room thumbnail, the user can check the party room entry screen 10 shown in FIG. 8, and through the screen 10, the user can check the video 11 output from the camera of the participant's device, the title 12 of the party room, the number of participants in the party room, and can enter the party room after setting his/her camera on/off and microphone on/off (S1100).

Next, the user can set whether or not to support a fellow streamer via a hand raise function 48 (S1200).

Next, if you are selected as a fellow streamer by the host streamer terminal (S1300, Y), the video output from the selected fellow streamer's terminal, i.e., the participant terminal, is output to the corresponding fellow streamer's area in the party room, and the screen can be shared (S1400). In other words, you participate in the live streaming as a fellow streamer.

If they are not selected as a fellow streamer in the party room (S1300,N), they will join as a viewer watching the livestream (S1500) and can participate in the livestream using the chat function.

As a result, the community live streaming system and method of the present disclosure enables a host streamer to select streamers to collaborate with from among the participants participating in the live stream to live stream live content together.

Embodiments of the present invention have been described in more detail with reference to the accompanying drawings, but the invention is not necessarily limited to these embodiments and may be practiced in various modifications without departing from the technical ideas of the invention. Accordingly, the embodiments disclosed herein are intended to illustrate and not to limit the technical ideas of the invention, and the scope of the technical ideas of the invention is not limited by these embodiments. Therefore, the embodiments described above are exemplary in all respects and should be understood as non-limiting. The scope of protection of the present invention shall be construed in accordance with the following claims, and all technical ideas within the scope thereof shall be construed as falling within the scope of the present invention.

What is claimed is:

1. A community live streaming system, comprising:
a plurality of user terminals; and
a server providing a live streaming service,
wherein the plurality of user terminals comprises:
a host streamer terminal for creating a party room; and
at least one participant terminal for participating in the party room,
wherein the server comprises:
a setting checking unit for checking on/off status of a camera and microphone of the at least one participant terminal upon receiving a request to enter the party room from the at least one participant terminal;
a network quality measurement unit for accessing the network quality of the at least one participant terminal;
a candidate streamer list generation unit for providing a list of candidate streamers to the host streamer terminal, the list being based on the on/off status of the camera and microphone and the network quality of the at least one participant terminal; and
a service support unit for outputting camera images from the host streamer terminal and a selected terminal among the at least one participant terminal to predetermined areas on a live streaming screen and providing said images to the plurality of user terminals participating in the party room,
wherein the selected terminal is selected as a fellow streamer by the host streamer terminal.

2. The community live streaming system of claim 1,
wherein the network quality measurement unit is further configured to determine a network quality rating based on bandwidth, latency, packet loss, and playback buffer latency of the at least one participant terminal, and wherein the service support unit is further configured to support differentiated video qualities depending on the network quality rating of the at least one participant terminal.

3. The community live streaming system of claim 2,
wherein the candidate streamer list generation unit is configured to provide a list of candidate streamers to the host streamer terminal comprising participant information corresponding to the at least one participant terminal with the camera and microphone turned on and arranged in order of increasing network quality rating.

4. The community live streaming system of claim 1, further comprising:
a management unit configured to store and manage user information party room information, and participant activity history, the user information including personal and interest information; and
a recommendation unit configured to compare the user information of one of the user terminals with the party room information and user information of other user terminals including the host streamer terminal, respectively, and recommend party rooms and host streamers in order of taste similarity to said one of the user terminals.

5. The community live streaming system of claim 4, further comprising:
a similarity calculator configured to calculate similarity of a party room by comparing the party room information with the user information and activity history of said one of the user terminals,
wherein the candidate streamer list generation unit is further configured to generate a list of candidate streamers based on the on/off status of cameras and microphones on the at least one participant terminal, network quality, and similarity to the party room.

6. The community live streaming system of claim 5,
wherein the user information includes at least one of age, gender, country/region, and language, and categorical interest information, the party room information includes at least one of category, party room title, party room description, related tags, and capacity, and the participant activity history information includes at least one of number and frequency of party room participation, donation information, party evaluation score, number of fellow streamer requests, and number of fellow streamer selections.

7. The community live streaming system of claim 2, further comprising:
a UI generation unit configured to provide a user interface (UI) to the user terminal when the party room is created, wherein the UI comprises a background area, multiple split screen areas nested within the background area, and multiple function icons,
wherein the multiple split screen areas include multiple camera output areas of fellow streamers centered on the camera output area of the host streamer terminal, each camera output area of the fellow streamers having a set seat number.

8. The system of claim 7, further comprising:
a pre-screening screen, wherein when a camera output area representing a fellow streamer position is selected at the host streamer terminal, a list of candidate streamers including participant information is provided to the pre-screening screen and the pre-screening screen allows the host streamer to select a fellow streamer for the corresponding seat number of the fellow streamer position.

9. The system of claim 7,
wherein the UI generation unit provides a pre-screening screen which is associated with the corresponding seat number for a fellow streamer position when a camera output area representing the fellow streamer position is selected at the host streamer terminal,
wherein the prescreening screen includes: a candidate preview having participant information and camera output images of one of the participant terminals, the candidate preview being sorted by priority of the candidate streamers; and a main frame area providing the highest prioritized candidate streamer overlapped on the preview.

10. The system of claim 9,
wherein, when the host streamer terminal selects one of the candidate streamers on the main frame area, the service support unit outputs, at the split screen area of the corresponding seat number, the camera output images of the corresponding participant terminal associated with said one of the candidate streamers.

11. A method for providing community live streaming in a system comprising a host streamer terminal for creating a party room, a plurality of user terminals including participant terminals for participating in the party room, and a server for providing live streaming services, the method comprising:
(a) creating a party room by the host streamer terminal;
(b) receiving a party room entry request from one of the participant terminals and checking the on/off status of the camera and microphone of said one of the participant terminals by the server;
(c) assessing a network quality of the participant terminals by the server;
(d) providing a list of candidate streamers to the host streamer terminal by the server, the list including on/off status of the camera and microphone and the network quality of the participant terminals;
(e) selecting a fellow streamer by the host streamer terminal; and
(f) outputting camera images from the host streamer terminal and camera images of the participant terminals selected as fellow streamers to a predetermined area of a live streaming screen and providing the live streaming screen to the participant terminals.

12. The method of claim 11,
wherein the step (c) determines a network quality rating based on communication bandwidth, latency, packet loss, and playback buffer latency of the participant terminals,
wherein the step (f) supports differentiated video quality based on the network quality rating of the participant terminals.

13. The method of claim 12,
wherein the step (d) provides to the host streamer terminal the list of candidate streamers further comprising participant information corresponding to the participant terminals with the cameras and microphones turned on and arranged in order of the network quality rating.

14. The method of claim 11, further comprising:
storing and managing user information, party room information, and participant activity history information by the server, the user information including personal and interest information; and
comparing user information of one of the participant terminals with the party room information and user information of other terminals including the host streamer terminal, respectively, and recommending party rooms and host streamers in order of taste similarity to a user terminal corresponding to said one of the participant terminals.

15. The method of claim 14, further comprising:
comparing the party room information with the user information and the participant activity history of the participant terminals to calculate a similarity to the party room,
wherein the step (d) further comprises generating the list of candidate streamers based on the on/off status of cameras and microphones on the participant terminals, network quality, and similarity to the party room.

16. The method of claim 15,
wherein the user information includes personal information comprising at least one of age, gender, country/region, and language, and categorical interest information; the party room information includes at least one of category, party room title, party room description, related tags, and capacity; and the participant activity history information includes at least one of number and frequency of party room participation, donation information, party evaluation score, number of fellow streamer requests, and number of fellow streamer selections.

17. The method of claim 12, further comprising:
providing a live streaming screen to the host streamer terminal upon creation of the party room by the server,
wherein the live streaming screen comprises a background area, multiple split screen areas nested within the background area, and multiple function icons,
wherein the multiple split screen areas include a plurality of camera output areas of fellow streamers centered around the camera output area of the host streamer terminal, with a seat number set in the camera output area of each fellow streamer.

18. The method of claim 17, further comprising:
providing a pre-screening screen which is associated with a corresponding seat number for a fellow streamer position when a camera output area representing the fellow streamer position is selected at the host streamer terminal.

19. The method of claim 18,
wherein the prescreening screen includes: a candidate preview having participant information and camera output images of one of the participant terminals, the candidate preview being sorted by priority of the candidate streamers; and a main frame area providing the highest prioritized candidate streamer overlapped on the preview.

20. The method of claim 19,
wherein the step (d) comprises outputting the camera output images the camera output images of the corresponding participant terminal associated with said one of the candidate streamers at the split screen area of the corresponding seat number when the host streamer terminal selects one of the candidate streamers on the main frame area.
